(19) United States
(12) Patent Application Publication
(10) Pub. No.: US 2026/0352457 A1
(43) Pub. Date: Nov. 5, 2026

(54) AUTOMATED LIGHTWEIGHT CERTIFICATE RENEWAL, DETECTION OF TLS VULNERABILITIES, AND VALIDITY VERIFICATION

(71) Applicant: Beijing Zitiao Network Technology Co., Ltd., Beijing (CN)

(72) Inventor: Kenney HE, Wilmington, DE (US)

(21) Appl. No.: 19/194,182

(22) Filed: Apr. 30, 2025

(51) Int. Cl. H04L 9/08; G06F 9/455; H04L 9/32

(52) U.S. Cl. CPC H04L 9/0891; G06F 9/45558; H04L 9/3263; G06F 2009/45562

(57) ABSTRACT

The present disclosure involves methods, apparatus, and systems for verifying a chain of trust and certificates including: collecting a plurality of signed certificates into a min-heap structure based on a date of expiration; traversing the min-heap structure and identifying a subset of certificates that are expiring within a predetermined threshold; identifying, from the subset of certificates that are expiring within the predetermined threshold, one or more certificates that are not locally owned; and sending a message requesting renewal for the one or more certificates that are not locally owned to an owner of the one or more certificates that are not locally owned.

### TECHNICAL FIELD

The present disclosure generally relates to verifying certificates at scale.

### BACKGROUND

Certificates are used to verify or authorize access to certain secure content. A chain of trust (or “chain”) in security certificates is a hierarchical system that ensures authenticity and integrity of digital certificates, such as those used for secure websites (e.g., using SSL/TLS). The chain can originate with a trusted root Certificate Authority (CA), which issues certificates either directly to end entities (such as a website) or to intermediate CAs. These intermediate CAs can then issue certificates to other entities, forming a chain. Each certificate in the chain can be cryptographically signed by the issuer above it, linking back to the root CA. Devices and browsers trust the root CA's public key, which can be pre-installed in their trust stores, and by verifying the signatures up the chain, they can trust the end certificate—confirming the identity of the website or service—without needing to trust every issuer individually. These certificates can assure confidentiality of encrypted communication.

### SUMMARY

The present disclosure relates to a method, system, and computer-readable storage media for verifying a chain of trust and certificates including: collecting a plurality of signed certificates into a min-heap structure based on a date of expiration; traversing the min-heap structure and identifying a subset of certificates that are expiring within a predetermined threshold; identifying, from the subset of certificates that are expiring within the predetermined threshold, one or more certificates that are not locally owned; and sending a message requesting renewal for the one or more certificates that are not locally owned to an owner of the one or more certificates that are not locally owned. Implementations can optionally include one or more of the following features.

In some instances, this can include: identifying, from the subset of certificates that are expiring within the predetermined threshold, one or more certificates that are locally owned; and renewing the one or more certificates that are locally owned.

In some instances, this includes returning metrics associated with the min-heap structure.

In some instances, the metrics comprise a list of current certificates and, for each current certificate, a time to expiration.

In some instances, prior to opening the network socket, instantiating a virtual machine to open the network socket; and after returning metrics associated with the min-heap structure, terminating the virtual machine.

In some instances, collecting the plurality of signed certificates into a min-heap structure comprises: opening a network socket to a certificate authority; downloading a chain of trust comprising a plurality of signed certificates using a secure sockets layer (SSL) or transport layer security (TLS); decrypting the plurality of signed certificates; and performing a min-heap algorithm on the decrypted certificates.

In some instances, downloading the chain of trust occurs after opening the network socket and prior to performing a communications handshake.

In some instances, traversing the min-heap structure comprises performing a verification of the signed certificates by: confirming no domain mismatch for each signed certificate; confirming that the chain of trust is not broken; and confirming the encryption algorithm is up to date.

According to a second aspect, one or more computer-readable storage media is provided. The one or more computer-readable storage media stores one or more instructions that, when executable by one or more computers, cause the one or more computers to perform the method according to the first aspect or one or more implementations of the first aspect.

According to a third aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect.

While generally described as computer-implemented software embodied on tangible media that processes and transforms the respective data, some or all of the aspects can be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system for verifying and renewing certificates.

FIG. 2 is a flowchart illustrating an example process for verifying and renewing certificates

FIG. 3 illustrates a schematic diagram of an example computing system.

Like reference numbers and designations in the various drawings indicate like elements.

### DETAILED DESCRIPTION

This specification relates to efficient, automated techniques for managing validation and renewal of certificates across multiple communications channels. Securing in-transit communication channels can require the exchange of certificates, which are authenticated by a trusted third party, such as a Certificate Authority (CA). An expiration date can be embedded within each certificate and is important for security and trust. Each certificate can link to another in a chain of trust (or “chain”). Quickly verifying the validity of signatures and identifying the soonest expiring certificate can be a complex task due to varying workflows. Numerous communication channels require verification daily to ensure we can renew and establish a new chain of certificates with valid signatures and expiration dates. This process is used to prevent a bad actor (e.g., malicious server) from intercepting communication by posing as a legitimate server. For example, a malicious actor could exploit a compromised certificate to redirect traffic to a fake website, thereby gaining access to sensitive information. Additionally, a certificate with an outdated encryption method can become vulnerable to attacks, necessitating renewal with a more secure encryption algorithm.

Further described is a fast TLS validation detection algorithm engineered to function smoothly with HTTP protocols such as QUIC. The algorithm can comprehensively scan chain certificate validations during detection and report the results promptly. The algorithm can identify misconfigurations of certificates that occur during PKI installation on both remote and local websites. To perform this, checks for domain mismatches between the site's domain and the issued certificate domain across all chain certificates occur. Further the disclosed solution is also capable of detecting the use of outdated encryption algorithms like SHA-1, which are related to OWASP 2013-A6 and OWASP 2017-A3 vulnerabilities, as well as detecting broken certificate chains of trust. Moreover, the detected TLS errors can be used to quickly resolve high qubit errors, thereby enabling a faster and more secure quantum network channel, providing a multi-faceted solution for enhanced TLS security in modern network setups. This can additionally apply to misconfiguration of the certification during installation. For example, using a private key instead of public key from a bad proxy setting.

The following are problems and vulnerabilities this fast detection algorithm solves: OWASP 2013-A6 (weak or none tls), OWASP 2017-A3, ISO27001-A.14.1.3, PCI v3.2-6.5.4, WASC-4, CVSS:3.0/AV/AC/PR/UI/S/C/I/A, CWE-295, and CAPEC-45.

This disclosure introduces an approach to certificate management that leverages a min-heap data structure to efficiently track and manage certificate expiration dates across numerous communication channels. The min-heap algorithm facilitates rapid detection of the earliest expiring certificate and can be used without typical handshake protocols. Thus, the disclosed solution functions regardless of handshake issues such as self-signed certificates or malformed secure socket layer (SSL/TLS) certificates. This system efficiently traverses the certificate chain and provides a data structure that is integrated into a serverless function that can trigger an automatic renewal process (e.g., 60 days) before the certificate's expiration date, ensuring uninterrupted communication.

This disclosure further describes a system that allows for efficient auditing of services that may utilize self-signed internal web services or have malformed SSL/TLS certificates, which are often overlooked in conventional manual processes. The automated nature of the system is particularly beneficial for enterprise environments where a large number of certificates are used across many communication channels. The daily monitoring capability ensures that potential security risks associated with expired or invalid certificates are identified and addressed promptly, minimizing the risk of communication disruptions and security vulnerabilities. Additionally, the disclosed system can act as a fast and secure notary verification service, or perform a fast scan for invalid and misconfigured service using malformed certificate chains.

The integration of the certificate management system with a serverless function provides a cost-effective and scalable solution for automated certificate renewal. This approach eliminates the need for complex and expensive infrastructure while enabling the system to easily adapt to the needs of various environments, from large enterprises to smaller home offices. The automated renewal process minimizes downtime and enhances overall security posture. Further the disclosed method for collecting certificate information, even after a failed handshake allows the system to provide valuable insights and alerts even when dealing with self-signed or malformed certificates, which are often ignored by traditional methods. This ensures comprehensive monitoring and proactive identification of potential security risks.

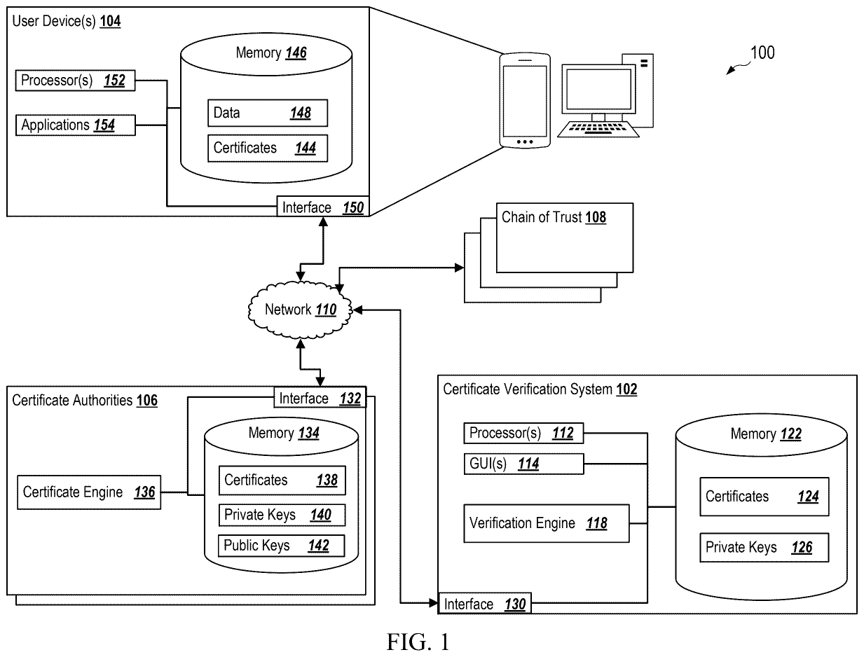

FIG. 1 illustrates a block diagram of an example system 100 for verifying and renewing certificates. The system 100 includes a certificate verification system 102, one or more user devices 104, one or more certificate authorities 106, and a chain of trust 108, which can communicate using a network 110.

Network 110 facilitates wireless or wireline communications between the components of the system 100 (e.g., between the certificate verification system 102, and the user devices 104), as well as with any other local or remote computers, such as additional mobile devices, clients, servers, or other devices communicably coupled to network 110, including those not illustrated in FIG. 1. In the illustrated environment, the network 110 is depicted as a single network, but can comprise more than one network without departing from the scope of this disclosure, so long as at least a portion of the network 110 can facilitate communications between senders and recipients. In some instances, one or more of the illustrated components (e.g., the certificates 124 and the memory 122) can be included within or deployed to network 110 or a portion thereof as one or more cloud-based services or operations. The network 110 can be all or a portion of an enterprise or secured network, while in another instance, at least a portion of the network 100 can represent a connection to the Internet. In some instances, a portion of the network 110 can be a virtual private network (VPN). Further, all or a portion of the network 110 can comprise either a wireline or wireless link. Example wireless links can include 802.11a/b/g/n/ac, 802.20, worldwide interoperability for microwave access (WiMax), long-term evolution (LTE), and/or any other appropriate wireless link. In other words, the network 110 encompasses any internal or external network, networks, sub-network, or combination thereof operable to facilitate communications between various computing components inside and outside the illustrated system 100. The network 110 can communicate, for example, Internet Protocol (IP) packets, Frame Relay frames, Asynchronous Transfer Mode (ATM) cells, voice, video, data, and other suitable information between network addresses. In some implementations, communications over the network 110 include InfiniBand communications. The network 110 can also include one or more local area networks (LANs), radio access networks (RANs), metropolitan area networks (MANs), wide area networks (WANs), all or a portion of the Internet, and/or any other communication system or systems at one or more locations.

The certificate verification system 102 can be a server-or web-based system that enables validation, renewal, and access to one or more repositories of certificates (e.g., chain of trust 108). The certificate verification system 102 can access the chain of trust 108 and perform analysis on one or more certificates to identify certificates that will expire soon, or within a predetermined threshold and send requests for renewals or self-renew certain certificates. The certificate verification system 102 can include one or more processors 112, a graphical user interface (GUI) 114, and a verification engine 118. The certificate verification system 102 can also include a memory 122, which can store one or more local certificates 124, as well as private keys 126 associated with the local system or the certificate verification system 102.

Each of the one or more processors 112 can be a central processing unit (CPU), an application specific integrated circuit (ASIC), a field-programmable gate array (FPGA), or another suitable component. Generally, the processor 112 executes instructions and manipulates data to perform the operations of the certificate verification system 102. Specifically, the processor 112 executes the algorithms and operations described in the illustrated figures, as well as the various software modules and functionality, including the functionality for sending communications to and receiving transmissions from the certificate authorities 106, as well as to other devices and systems. Each processor 112 can have a single or multiple cores, with each core available to host and execute an individual processing thread. Further, the number of, types of, and particular processors 112 used to execute the operations described herein can be dynamically determined based on a number of requests, interactions, and operations associated with the certificate verification system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including Python, C, C++, JavaScript, Java™, Visual Basic, assembler, Perl®, any suitable version of fourth-generation programming language (4GL), as well as others.

GUI 114 of the certificate verification system 102 interfaces with at least a portion of the system 100 for any suitable purpose, including generating a visual representation of any particular application or results and/or the content associated with any components of the user devices 104. In particular, the GUI 114 can be used to present results of a query or search, or allow a developer to review certificate status and overall function of the certificate verification system 102, as well as to otherwise interact and present information associated with one or more applications. GUI 114 can also be used to view and interact with various web pages, applications, and web services located local or external to the certificate verification system 102. Generally, the GUI 114 provides the user with an efficient and user-friendly presentation of data provided by or communicated within the system. The GUI 114 can include a plurality of customizable frames or views having interactive fields, pull-down lists, and buttons operated by the user. In general, the GUI 114 is often configurable, supports a combination of tables and graphs (e.g., bar, line, pie, and/or status dials), and is able to build real time portals, application windows, and presentations. Therefore, the GUI 114 contemplates any suitable GUI, such as a combination of a generic web browser, a web-enabled application, intelligent engine, and command line interface (CLI) that processes information in the platform and efficiently presents the results to the user visually.

Memory 122 can represent a single memory or multiple memories. The memory 122 can include any memory or database module and can take the form of volatile or non-volatile memory including, without limitation, magnetic media, optical media, random access memory (RAM), read-only memory (ROM), removable media, or any other suitable local or remote memory component. The memory 122 can store various objects or data, including digital asset data, public keys, user and/or account information, administrative settings, password information, caches, applications, backup data, repositories storing business and/or dynamic information, and any other appropriate information associated with the certificate verification system 102, including any parameters, variables, algorithms, instructions, rules, constraints, or references thereto. Additionally, the memory 112 can store any other appropriate data, such as local certificates 124, user profiles, algorithms, or processes, firmware logs and policies, firewall policies, a security or access log, print or other reporting files, as well as others. While illustrated within the system 100, memory 122 or any portion thereof, including some or all of the particular illustrated components, can be located remote from the system 100 in some instances, including as a cloud application or repository or as a separate cloud application or repository when the system 100 itself is a cloud-based system.

The verification engine 118 can be a program or application that periodically (e.g., every hour, every day, or every week) verifies the chain of trust 108 and its certificates. In general, the verification engine 118 can review the chain of trust 108 and generate a min-heap binary data structure based on the expiration of the certificates. Certificates that have an expiry of less than a predetermined amount (e.g., 60 days, 30 days, 7 days, etc.) can be flagged and the verification engine 118 can send a message to the appropriate certificate authority 106 or owner of the certificate requesting it be renewed. In some implementations, where the certificate is locally owned or self-signed, the verification engine 118 can access private keys 126, or local certificates 124 and sign/renew the certificate locally.

The verification engine 118, can access the chain of trust 108 directly via a network socket. In some implementations, the verification engine 118 opens a network socket, and immediately downloads the entire chain of trust 108, that is, all the certificates, without performing any initial handshake protocol or verification. Once the certificates are downloaded, they can be decrypted, arranged using a min-heap algorithm, and verified.

Interface 130 is used by the certificate verification system 102 to communicate with other systems in a distributed environment—including within the system 100—connected to the network 110 (e.g., user devices 104), and other systems communicably coupled to the illustrated certificate verification system 102 and/or network 110. Generally, the interface 130 includes logic encoded in software and/or hardware in a suitable combination and operable to communicate with the network 110 and other components. More specifically, the interface 130 can include software supporting one or more communication protocols associated with communications such that the network 110 and/or interface's 130 hardware is operable to communicate physical signals within and outside of the illustrated system 100. Still further, the interface 130 can allow the certificate verification system 102 to communicate with the user devices 104, certificate authorities 106, and/or other portions illustrated within the system 100 to perform the operations described herein.

Chain of trust 108 can be a hierarchical system that ensures the authenticity and integrity of digital certificates, such as those used for secure websites (SSL/transport layer security (TLS)). The chain can originate with a trusted root CA 106, which issues certificates either directly to end entities (such as a website) or to intermediate CAs 106. These intermediate CAs 106 can then issue certificates to other entities, forming a chain. Each certificate in the chain can be cryptographically signed by the issuer above it, linking back to the root CA. Devices and browsers trust the root CA's public key, which can be pre-installed in their trust stores, and by verifying the signatures up the chain, they can trust the end certificate—confirming the identity of the website or service—without needing to trust every issuer individually. While illustrated as separate, in some implementations the chain of trust 108, or portions thereof are stored in a memory of the CA 106, or other locations (e.g., some certificates can be stored in memory 122). In some implementations, the certificates are TLS X.509 certificates which include a subject or entity that the certificate is issued to, an issuer, which is usually a CA 106, a public key, a validity period, and the issuer's digital signature.

Certificate authorities 106 can issue, assign, and renew certificates 138. The CAs 106 can include a certificate engine 136, which manages the cryptography and functions to issue certificates to particular entities for certain valid time periods. The CAs 106 can communicate using interface 132, which can be similar to or different from interface 130 as described above.

Memory 134, which can be similar to or different from memory 122 as described above, stores certificates 138, and private keys 140 which are used to sign certificates 138, as well as public keys 142, which can be published and used by entities to verify the digital signature of the CA 106.

User devices 104 can be computing devices or computers used by one or more users and developers of the software and hardware within system 100. For example, the user devices 104 can interact with the CAs 106 to get certificates 144 and access secure information or open secure communications channels. As used in the present disclosure, the term “computer” or “computing devices” is intended to encompass any suitable processing device. For example, the user devices 104 can be any computer or processing device such as, for example, a blade server, general-purpose personal computer (PC), Mac® workstation, UNIX-based workstation, or any other suitable device. In other words, the present disclosure contemplates computers other than general-purpose computers, as well as computers without conventional operating systems. The user devices 104, in some instances, can be desktop systems, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The user devices 104 can include one or more specific applications 154 executing on the user devices 104, or the user devices 104 can include one or more Web browsers or web applications that can interact with particular applications executing remotely from the user devices 104. User devices 104 can include a memory 146, which can be similar to or different from memory 122 and can store device data 148. The user devices 104 can include an interface 150 which enables communication with other components of system 100, and can be similar to interface 130.

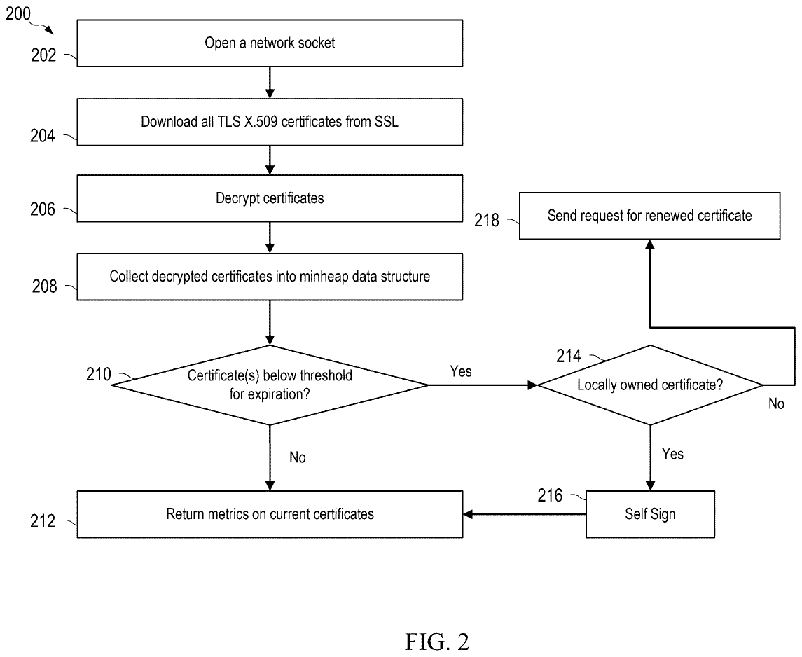

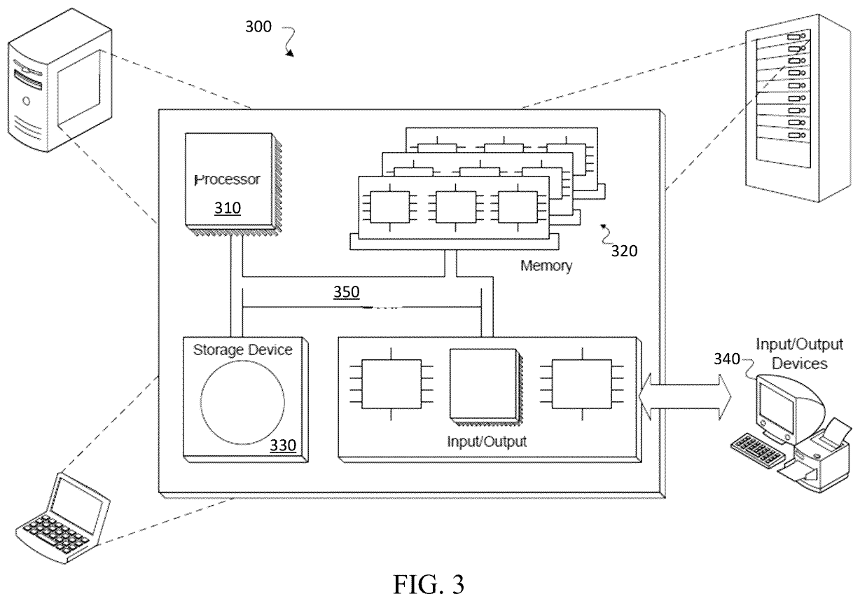

FIG. 2 is a flowchart illustrating an example process 200 for verifying and renewing certificates. The example process 200 can be performed by a system for example, system 100 as described above with respect to FIG. 1. The operations shown in process 200 may not be exhaustive and other operations can be performed as well before, after, or in between any of the illustrated operations. Further, some of the operations may be performed simultaneously, or in a different order than shown in FIG. 2. In some implementations, some of the operations may be performed by a computer, or multiple computers. The one or more computers the process 200 will be described as being performed by a system of, located in one or more locations, and programmed appropriately in accordance with this specification. For example, one or more of a computation system 300 of FIG. 3, appropriately programmed, can perform the process 200.

At 202, a network socket is opened or established to provide communications between a certificate verification system and the certificates to be verified. In some implementations, a transmission control protocol (TCP) socket is opened. In some implementations, the socket is established as a listening socket, or connectionless socket that is set up to receive requests and send responses without establishing or confirming any handshake protocol.

At 204, the chain of trust, or the certificates within the chain of trust are downloaded. In some implementations, this download occurs immediately following establishment of the network socket. That is, this occurs prior to any handshake protocol or communication confirmations. By skipping the handshake, and directly downloading the certificates, the chain of trust can still be verified even if the connection is lost or unstable. Further, downloading the certificates can require less connection time, as the downloaded certificates can be readily verified offline. In some implementations, the downloaded certificates are TLS X.509 type certificates.

At 206, the downloaded certificates are decrypted. The certificates can be encrypted using symmetric or asymmetric encryption to ensure secure transmission of the certificates. In some implementations, the certificates are decrypted using a public key of the CA from which the certificates were downloaded.

At 208, with the certificates decrypted, they can be collected using the min-heap algorithm based on their expiration. The collected certificates can be sorted into a binary data structure with sooner expiration near the top of the data structure. The min-heap algorithm can provide an efficient method for sorting the certificates and rapidly confirming the validity of the chain of trust (e.g., that no certificates are expired) and identifying certificates that need further action (e.g., a renewal request).

At 210, it is determined whether there are any certificates in the min-heap data structure that have an expiration below a predetermined threshold. The predetermined threshold can be, for example, 60 days, 7 days, 6 months, 5 hours, or other period of time. In some implementations, the predetermined threshold is based on a verification frequency. For example, if the chain of trust is verified every hour, the minimum threshold can be 2 days. In another example, if the chain of trust is verified weekly, the minimum threshold can be 60 days. If no certificates in the chain of trust expire in less than the threshold, then process 200 can continue at 212.

At 212, with the certificates arranged by the min-heap algorithm into the binary data structure, metrics or analytics can be performed. For example, a summary of the number of certificates, which encryption protocols they are using, and who the associated CAs are can be generated. Additionally metrics such as number of services provided, or time to perform verification can be calculated. Finally, each certificate in the chain of trust can be verified using the public key of that certificate to confirm the digital signature within that certificate. Each public key can be compared, for example, to a published list of public keys provided by the respective CAs. Additionally the certificates can be analyzed to detect and/or report any information such as expiry time, name, and encryption method associated with each certificate.

Returning to 210, if one or more certificates are expiring within the predetermined threshold, process 200 can instead proceed at 214, where it is determined whether the expiring certificate (or certificates) are locally owned or endorsed.

For locally owned, or endorsed certificates at 216, the certificate verification system can renew the certificate by providing an updated certificate and digital signature using a local private key.

If the expiring certificates are not locally owned, a message or request can be sent at 218 for the certificate can be renewed. In some implementations, for example when the verification occurs with a daily periodicity, a renewal request message is sent to the associated CA every day when the verification occurs until the certificate is renewed. In some implementations, the request can be sent at a different periodicity that is distinct from process 200 (e.g., weekly, hourly, etc.).

FIG. 3 illustrates a schematic diagram of an example computing system 300. The system 300 can be used for the operations described in association with the implementations described herein. For example, the system 300 may be included in computing devices of the one or more online components and/or the one or more offline components. The system 300 includes a processor 310, a memory 320, a storage device 330, and an input/output device 340, which are interconnected using a system bus 350. The processor 310 is capable of processing instructions for execution within the system 300. In some implementations, the processor 310 is a single-threaded processor. The processor 310 is a multi-threaded processor. The processor 310 is capable of processing instructions stored in the memory 320 or on the storage device 330 to display graphical information for a user interface on the input/output device 340.

The memory 320 stores information within the system 300. In some implementations, the memory 320 is a computer-readable medium. The memory 320 can be a volatile memory unit or a non-volatile memory unit. The storage device 330 is capable of providing mass storage for the system 300. The storage device 330 is a computer-readable medium. The storage device 330 may be a floppy disk device, a hard disk device, an optical disk device, or a tape device. The input/output device 340 provides input/output operations for the system 300. The input/output device 340 includes a keyboard and/or pointing device. The input/output device 340 includes a display unit for displaying graphical user interfaces.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship with each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required to be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations but should be defined only in accordance with the following claims and their equivalents. Accordingly, other implementations also are within the scope of the claims.

1. A computer-implemented method, comprising:
collecting a plurality of signed certificates into a min-heap structure based on a date of expiration;
traversing the min-heap structure and identifying a subset of certificates that are expiring within a predetermined threshold;
identifying, from the subset of certificates that are expiring within the predetermined threshold, one or more certificates that are not locally owned; and
sending a message requesting renewal for the one or more certificates that are not locally owned to an owner of the one or more certificates that are not locally owned.

2. The method of claim 1, comprising:
identifying, from the subset of certificates that are expiring within the predetermined threshold, one or more certificates that are locally owned; and
renewing the one or more certificates that are locally owned.

3. The method of claim 1, comprising:
returning metrics associated with the min-heap structure.

4. The method of claim 3, wherein the metrics comprise a list of current certificates and, for each current certificate, a time to expiration.

5. The method of claim 3, comprising:
prior to opening the network socket, instantiating a virtual machine to open the network socket; and
after returning metrics associated with the min-heap structure, terminating the virtual machine.

6. The method of claim 1, wherein collecting the plurality of signed certificates into a min-heap structure comprises:
opening a network socket to a certificate authority;
downloading a chain of trust comprising a plurality of signed certificates using a secure sockets layer (SSL) or transport layer security (TLS);
decrypting the plurality of signed certificates; and
performing a min-heap algorithm on the decrypted certificates.

7. The method of claim 6, wherein downloading the chain of trust occurs after opening the network socket and prior to performing a communications handshake.

8. The method of claim 1, wherein traversing the min-heap structure comprises performing a verification of the signed certificates by:
confirming no domain mismatch for each signed certificate;
confirming that the chain of trust is not broken; and
confirming the encryption algorithm is up to date.

9. One or more computer-readable storage medium storing one or more instructions that, when executable by one or more computers, cause the one or more computers to perform operations comprising:
collecting a plurality of signed certificates into a min-heap structure based on a date of expiration;
traversing the min-heap structure and identifying a subset of certificates that are expiring within a predetermined threshold;
identifying, from the subset of certificates that are expiring within the predetermined threshold, one or more certificates that are not locally owned; and
sending a message requesting renewal for the one or more certificates that are not locally owned to an owner of the one or more certificates that are not locally owned.

10. The medium of claim 9, comprising:
identifying, from the subset of certificates that are expiring within the predetermined threshold, one or more certificates that are locally owned; and
renewing the one or more certificates that are locally owned.

11. The medium of claim 9, the operations comprising:
returning metrics associated with the min-heap structure.

12. The medium of claim 11, wherein the metrics comprise a list of current certificates and, for each current certificate, a time to expiration.

13. The medium of claim 11, the operations comprising:
prior to opening the network socket, instantiating a virtual machine to open the network socket; and
after returning metrics associated with the min-heap structure, terminating the virtual machine.

14. The medium of claim 10, wherein collecting the plurality of signed certificates into a min-heap structure comprises:
opening a network socket to a certificate authority;
downloading a chain of trust comprising a plurality of signed certificates using a secure sockets layer (SSL) or transport layer security (TLS);
decrypting the plurality of signed certificates; and
performing a min-heap algorithm on the decrypted certificates.

15. The medium of claim 14, wherein downloading the chain of trust occurs after opening the network socket and prior to performing a communications handshake.

16. A computer-implemented system, comprising:
one or more computers; and
one or more computer memory devices interoperably coupled with the one or more computers and having computer-readable storage media storing one or more instructions that, when executed by the one or more computers, perform one or more operations comprising:
collecting a plurality of signed certificates into a min-heap structure based on a date of expiration;
traversing the min-heap structure and identifying a subset of certificates that are expiring within a predetermined threshold;
identifying, from the subset of certificates that are expiring within the predetermined threshold, one or more certificates that are not locally owned; and
sending a message requesting renewal for the one or more certificates that are not locally owned to an owner of the one or more certificates that are not locally owned.

17. The system of claim 16, comprising:
identifying, from the subset of certificates that are expiring within the predetermined threshold, one or more certificates that are locally owned; and
renewing the one or more certificates that are locally owned.

18. The system of claim 16, the operations comprising:
returning metrics associated with the min-heap structure.

19. The system of claim 18, wherein the metrics comprise a list of current certificates and, for each current certificate, a time to expiration.

20. The system of claim 18, the operations comprising:
prior to opening the network socket, instantiating a virtual machine to open the network socket; and
after returning metrics associated with the min-heap structure, terminating the virtual machine.
